(19) United States
(12) Patent Application Publication
(10) Pub. No.: US 2026/0038855 A1
(43) Pub. Date: Feb. 5, 2026

(54) CONTROLLING FREEZE PROTECTION FOR A FUEL CELL VEHICLE

(71) Applicant: VOLVO TRUCK CORPORATION, Göteborg (SE)

(72) Inventors: Pranav ARYA, Lindome (SE); Gregory HART, Göteborg (SE)

(73) Assignee: VOLVO TRUCK CORPORATION, Göteborg (SE)

(21) Appl. No.: 18/996,356

(22) PCT Filed: Jul. 19, 2022
(86) PCT No.: PCT/EP2022/070226

§ 371 Date: Jan. 17, 2025

(51) Int. Cl. H01M 8/04223; B60L 50/60; B60L 50/70; B60L 58/30; B60L 58/40; H01M 8/04228; H01M 8/04303

(52) U.S. Cl. CPC H01M 8/04253; B60L 50/60; B60L 50/70; B60L 58/30; B60L 58/40; H01M 8/04228; H01M 8/04303; B60L 2200/36; B60L 2240/66; H01M 2250/20

(57) ABSTRACT

A computer-implemented method controls a power assembly of a vehicle having a plurality of fuel cell systems and an electric energy storage system. The method includes estimating a duration of a vehicle stopover of the vehicle; determining whether a freeze protection is required during the vehicle stopover; and, if it is determined that the freeze protection is not required, shutting down the fuel cell system without enabling the freeze protection. If it is determined that the freeze protection is required, the method may comprise estimating a threshold time indicating a time at which a cost of keeping the fuel cell systems operational outweighs a cost of shutting down the fuel cell systems; and if the estimated duration of the vehicle stopover expires after the threshold time, shutting down the fuel cell systems and enabling the freeze protection.

### TECHNICAL FIELD

The disclosure relates generally to freeze protection for a fuel cell system in a vehicle. It further relates to a power assembly, a control unit, a vehicle, a computer program product, and a computer-readable medium.

The disclosure can be applied in heavy-duty vehicles, such as trucks, buses, and construction equipment.

### BACKGROUND

A fuel cell is an electro-chemical device that includes an electrolyte sandwiched between the two electrodes such as an anode and a cathode. Solid polymer electrolyte fuel cells, which employ a proton exchange, solid polymer membrane electrolyte, electrochemically convert reactants—fuel (such as hydrogen) and oxidant (such as oxygen or air), to generate electric power. The anode receives hydrogen gas and the cathode receives oxygen or air. A structure comprising a solid polymer membrane electrolyte sandwiched between these two electrodes is referred to a membrane electrode assembly (MEA). A plurality of fuel cells are usually arranged together in a fuel cell stack, in order to provide a higher output voltage. Also, multiple fuel cell stacks may be assembled together to form a fuel cell system.

Primary by-products of electrochemical reactions taking place within a fuel cell are water and heat. Thus, proton exchange membrane fuel cell (PEMFC) vehicles (PEMFCV) have recently received increased attention due to the advantages of low or zero emissions.

In certain applications, in use, fuel cells may be subjected to repeated on-off duty cycles involving periods of inactivity (e.g., storage or off-duty conditions) for varied lengths of time and at varied temperatures. It is generally desirable to be able to reliably start-up fuel cells in a short period of time. For example, automotive applications may require relatively fast, reliable start-up from a shut-down state at sub-zero environmental temperatures, e.g., well below freezing. At the same time, water management in fuel cells at such temperatures presents a challenge due to possible ice formation, which is particularly undesirable during a start-up from a sub-zero ambient temperature. The presence of water in the liquid phase in a fuel cell system is particularly undesirable at sub-zero temperatures since the MEA in the fuel cell system may be subject to degradation and destruction by ice formation and expansion. In general, operation of fuel cells at below freezing temperatures may cause irreversible performance loss of the fuel cells, which may significantly affect a reliability and the overall lifetime of the fuel cell. For example, structural changes may occur in the cathode catalyst later, which can deform or even detach or delaminate from the membrane.

Various methods have been proposed for operation and storing of fuel cells in anticipation of below freezing ambient conditions. If a fuel cell is expected to be subjected to sub-zero temperatures, certain start-up and shutdown techniques may be used. Freeze preparation procedures, especially if performed frequently, may result in certain degradation in performance of the fuel cells.

Thus, despite the advances made to date, there remains a need for improved methods for appropriate managing of fuel cell systems in sub-zero temperature conditions and in anticipation of such conditions.

### SUMMARY

The object of embodiments of the present disclosure is to address the above need in improved techniques for managing fuel cell systems, e.g., in a vehicle, in anticipation of sub-zero ambient temperatures.

Embodiments of the present disclosure provide a technique that addresses the above need. In particular, a method is provided for managing a fuel cell system in a power assembly of a vehicle in a manner that considers data related to, e.g., a duration of a stopover of a vehicle, data related to the fuel cell system, ambient weather, and information on a driver of the vehicle, to determine whether and when to perform a freeze protection or preparation.

Aspects of the present disclosure address the above need by providing a computer-implemented method of controlling a power assembly of a vehicle comprising a plurality of fuel cell systems and an electric energy storage system, the method determining whether and/or when to implement a freeze protection for the fuel cell systems.

The method in accordance with embodiments of the present disclosure allows making a decision regarding whether or not to perform a freeze protection in a fuel cell system of an electric vehicle. The electric vehicle, such as a fuel cell electric vehicle (FCEV), may be stopped, parked, or otherwise not in use, in which case there may be a risk of freezing of the vehicle's fuel cell system(s). The decision may be made based at least on a duration of a stopover or parking of the vehicle. Other non-limiting factors may include ambient conditions, power needs of the vehicle during the stopover, a cost of hydrogen consumption associated with keeping the fuel cell system operational, and expected degradation costs related to performing a freeze protection. The method in accordance with embodiments of the present disclosure results in an advantage of reducing or eliminating a risk of deterioration and damage of a fuel cell system, thereby improving lifetime and durability of the fuel cell systems. This allows reducing costs of operating and maintaining a vehicle, such as a FCEV, including at least one fuel cell system. Also, the vehicle's productivity and lifetime may be increased.

According to an aspect of the disclosure, a computer-implemented method of controlling a power assembly of a vehicle comprising a plurality of fuel cell systems and an electric energy storage system is provided. The method comprises estimating a duration of a vehicle stopover of the vehicle; determining whether a freeze protection is required during the vehicle stopover; and, if it is determined that the freeze protection is not required, shutting down the fuel cell system without enabling the freeze protection.

The method may further comprise, if it is determined that the freeze protection is required, estimating a threshold time indicating a time at which a cost of keeping the fuel cell systems operational outweighs a cost of shutting down the fuel cell systems; and, if the estimated duration of the vehicle stopover expires after the threshold time, shutting down the fuel cell systems and enabling the freeze protection.

According to an aspect of the disclosure, the object is achieved by an inventive concept disclosed herein. Hereby, a technical effect includes determining, based on a duration of a vehicle stopover, ambient conditions, and other factors, whether and when to perform a freeze protection, which results in an improvement and advantage of reducing a risk of degradation and damage of a fuel cell system. In this way, the lifetime and durability of the fuel cell system is increased. A method in accordance with embodiments of the present disclosure allows making decisions regarding shutting down fuel cell system(s) of the vehicle, performing a freeze protection of the fuel cell systems, keeping one or more of the fuel cell systems operational, and restarting a previously shut down fuel cell system(s), while taking into consideration various factors, including an estimated duration of a vehicle stopover, ambient conditions, driver input, historical data, actual power needs of the vehicle and/or of auxiliary devices during the stopover, as well as costs associated with shutting down the fuel cell systems and performing freeze protection and costs of keeping one or more of the fuel cell systems operational, during the vehicle stopover. In this way, a more informed and accurate decision can be made regarding the fuel cell system(s) of the vehicle, which advantageously improves the overall durability and thus lifetime of the fuel cell systems.

In certain examples, the method further comprises determining, using at least the estimated duration of the vehicle stopover, whether there are power needs from the vehicle during the vehicle stopover.

In certain examples, determining whether there are power needs from the vehicle during the vehicle stopover comprises determining whether a driver of the vehicle is sleeping in the vehicle during the vehicle stopover and/or whether the vehicle is parked.

In certain examples, whether the freeze protection is required during the vehicle stopover is determined when it is determined that there are no power needs from the vehicle during the vehicle stopover.

In certain examples, whether the freeze protection is required during the vehicle stopover is determined when it is determined that there are power needs from the vehicle during the vehicle stopover and the power needs can be fulfilled by the electric energy storage system during the vehicle stopover.

In certain examples, if it is determined that there are power needs from the vehicle during the vehicle stopover and the power needs cannot be fulfilled by the electric energy storage system during the vehicle stopover, the method further comprises keeping at least one fuel cell system of the fuel cell systems operational.

In certain examples, the method further comprises, if the estimated duration of the vehicle stopover expires before the threshold time, (1) keeping at least one fuel cell system of the fuel cell systems operational, or (2) restarting the at least one fuel cell system.

In certain examples, the at least one fuel cell system is restarted after a certain time period during which the plurality of fuel cell systems are shut down.

In certain examples, the method further comprises selecting the at least one fuel cell system by comparing values each representing a state of health of a respective fuel cell system of the plurality of fuel cell systems, and wherein the at least one fuel cell system has a highest value representing the state of health of the at least one fuel cell system. The at least one fuel cell system may be selected to be kept operational, or the at least one fuel cell system may be selected to be restarted, e.g., to keep the other fuel cell systems warm.

In certain examples, the threshold time is estimated using a first threshold time and a second threshold time, wherein the first threshold time is calculated for a case when the electric energy storage system is not capable of storing any of the power generated by the fuel cell systems during the vehicle stopover, and the second threshold time is calculated for a case when the electric energy storage system is capable of storing the entirety of power generated by the fuel cell systems during the vehicle stopover.

In certain examples, the duration of the vehicle stopover is estimated using one or more of a driver input, location information, ambient information, and historical data related to operation of the vehicle.

In certain examples, whether the freeze protection is required during the vehicle stopover is determined using current ambient conditions and predicted ambient conditions.

According to an aspect of the disclosure, a control unit is provided for controlling a power assembly of a vehicle comprising a plurality of fuel cell systems and an electric energy storage system, the control unit being configured to perform the method in accordance with embodiments of the present disclosure.

According to an aspect of the disclosure, a power assembly comprising a plurality of fuel cell systems and an electric energy storage system is provided, the power assembly further comprising the control unit.

According to an aspect of the disclosure, a vehicle is provided comprising the power assembly and/or being in communication with the control unit.

According to an aspect of the disclosure, a computer program product comprising instructions, which, when executed on at least one processor, cause the at least one processor to carry out the method in accordance with embodiments of the present disclosure.

According to an aspect of the disclosure, a computer-readable storage medium is provided. The computer-readable storage medium has stored thereon a computer program product comprising instructions which, when executed on at least one processor, cause the at least one processor to carry out the method in accordance with embodiments of the present disclosure.

Additional features and advantages are disclosed in the following description, claims, and drawings. Furthermore, additional advantages will be readily apparent from the present disclosure to those skilled in the art or recognized by practicing the disclosure as described herein. There are also disclosed herein control units, computer program products, and computer-readable media associated with the above discussed technical effects and corresponding advantages.

### BRIEF DESCRIPTION OF THE DRAWINGS

With reference to the appended drawings, below follows a more detailed description of aspects of the disclosure cited as examples.

FIG. 1 illustrates a side view of an example of a vehicle comprising a power assembly in which a method in accordance with aspects of the present disclosure may be implemented.

FIGS. 2A and 2B are flow charts illustrating an example of a method for controlling a power assembly of a vehicle, in accordance with aspects of the present disclosure.

FIGS. 3A and 3B are flow charts illustrating another example of a method for controlling a power assembly of a vehicle, in accordance with aspects of the present disclosure.

FIG. 4 is a graph illustrating an example of calculation of a threshold time tₜᵣ, in accordance with aspects of the present disclosure.

FIG. 5 is a graph illustrating another example of calculation of a threshold time tₜᵣ, in accordance with aspects of the present disclosure.

FIG. 6 are graphs illustrating another example of calculation of a threshold time ter, in accordance with aspects of the present disclosure.

FIGS. 7A and 7B are schematic block diagrams illustrating examples of a control unit, in accordance with aspects of the present disclosure.

### DETAILED DESCRIPTION

Fuel cell systems are typically sensitive to low temperatures, and they need to be protected against freezing to avoid their degradation or damage. A vehicle or another device including a fuel cell system may be present in an environment where temperatures fall below 0° C., sometimes much lower than 0° C., and in such conditions a risk of damage of fuel cells increases and capability of the fuel cells to produce energy may thus be negatively affected. Moreover, when a vehicle including a power source comprising a fuel cell system is stopped or parked in conditions with subzero temperatures, an ability of the vehicle to quickly and properly start up may be affected. At the same time, it is required that a vehicle can start properly in any ambient weather conditions, including at sub-freezing temperatures.

Various methods have been developed for protecting fuel cell systems from freezing during vehicle or another device stopping, or during storage of a fuel cell. The methods include external heating, purging of water before shutdown,, use of antifreeze, continuous operation of the fuel cell system, etc. There may be an irreparable damage to a fuel cell system in case the freeze protection fails or in case the fuel cell system cannot perform freeze protection later. Furthermore, a freeze preparation puts a certain burden on the fuel cell system and contributes to degradation of the fuel cell system which may ultimately reduce a lifetime of the fuel cell system and a host device equipped with such system. Also, the proper operation of a host device, such as a vehicle, employing the fuel cell system for power generation, is compromised when the fuel cell system is not adequately prepared for possible freezing conditions.

Accordingly, it is desirable to ensure that a freeze protection or preparation reliably occurs at a proper time, and it is desirable perform a freeze preparation of a fuel cell system with a lesser frequency, to reduce a risk of degradation of the fuel cell system. Despite the current advances and development of various approaches to protecting a fuel cell from being damaged at freezing ambient conditions, there remains a need for improved methods for appropriate protection of fuel cell systems from freezing, at near-zero or below-zero temperatures.

Accordingly, the object of embodiments of the present disclosure is to provide a method to determine whether and when to perform a freeze protection, e.g., to take certain measures to reduce or avoid a risk of damage to a fuel cell system due to sub-zero ambient temperature.

The object is achieved by providing a method of controlling a fuel cell system in a vehicle that comprises, based at least on a duration of a stopover of the vehicle, whether to shut down the fuel cell system without enabling a freeze protection, shut down the fuel cell systems and enable the freeze protection, keep at least one fuel cell system of the fuel cell systems operational, or restart at least one fuel cell system of the fuel cell systems.

Accordingly, a computer-implemented method of controlling a power assembly of a vehicle comprising a plurality of fuel cell systems and an electric energy storage system is provided herein. The method comprises estimating a duration of a vehicle stopover of the vehicle; determining whether a freeze protection is required during the vehicle stopover; and, if it is determined that the freeze protection is not required, shutting down the fuel cell system, without enabling the freeze protection. The method may further comprise, if it is determined that the freeze protection is required, estimating a threshold time indicating a time at which a cost of keeping the fuel cell systems operational outweighs a cost of shutting down the fuel cell systems; and if the estimated duration of the vehicle stopover expires after the threshold time, shutting down the fuel cell systems and enabling the freeze protection.

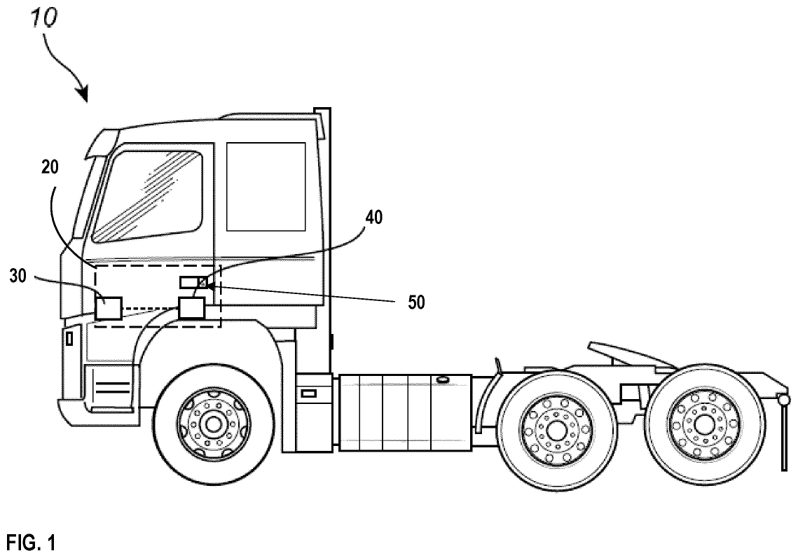

FIG. 1 depicts a side view of a vehicle 10 according to an example embodiment of the present disclosure. The vehicle 10 is shown as a truck, such as a heavy-duty truck for towing one or more trailers (not shown). The vehicle 10 may be a fuel cell electric vehicle (FCEV). It should be appreciated that the present disclosure is not limited to any other specific type of vehicle, and may be used for any other type of vehicle, such as a bus, construction equipment, e.g. a wheel loader or an excavator, a passenger car, an aircraft, and a marine vessel. The passenger car may be, e.g., a taxi or another ride sharing vehicle.

The present disclosure is also applicable for other applications not relating to vehicles, as long as a power assembly comprising at least one fuel cell system and an electric energy storage system (ESS) are utilized.

As shown schematically in FIG. 1, the vehicle 10 comprises a power assembly 20. The power assembly 20 may be used for powering one or more electric motors (not shown) which are used for creating a propulsion force to the vehicle 10. The power assembly 20 may additionally or alternatively be used for powering other electric power consumers (not shown) of the vehicle 10, such as an electric motor for a crane, an electric motor for a refrigerator system, an electric motor for an air conditioning system, or any other electric power consuming function of the vehicle 10. The power assembly 20 may thus additionally or alternatively be used for powering a power take-off (PTO) device that is a device that transfers an electric motor's mechanical power to another piece of equipment. The vehicle 10 may include or be coupled or associated with one or more PTO devices.

The power assembly 20 comprises at least one fuel cell unit or system 30, such as a plurality of fuel cell units or systems 30. Although not illustrated in detail, a fuel cell system comprises two or more fuel cells which together may form a fuel cell stack. Further, the fuel cell system is arranged to provide the fuel cells with necessary supply of hydrogen fuel (H₂) and air, cooling, etc., and the fuel cell system may include various components which are not shown herein. The at least one fuel cell system 30 may comprise multiple fuel cell systems, and each fuel cell system may comprise its own control system, which may be communicatively connected to a control unit 40. The power assembly 20 may comprise a single fuel cell system, two fuel cell systems, or more than two fuel cell systems, such as three or more fuel cell system. Furthermore, when several fuel cell units or systems are provided, the fuel cell systems may be either independently controllable or commonly controllable. When independently controllable, each fuel cell systems may be controlled to an on-state or an off-state regardless of the state(s) of the other fuel cell unit(s). When two or more of the fuel cell systems are commonly controllable, those fuel cell systems are controllable in common to an on-state or an off-state, i.e., all fuel cell systems are controlled in common to the same state. Two fuel cell systems may in some cases be controlled in dependence on one another, such that one of the fuel cell systems is controlled to an on-state or an off-state in dependence on the state of the other fuel cell system(s).

The vehicle 10 further comprises the control unit 40 according to an example embodiment of the present disclosure. The control unit 40 may be used for controlling the power assembly 20. Even though an on-board control unit 40 is shown, it shall be understood that the control unit 40 may also be a remote control unit 40, i.e. an off-board control unit, or a combination of an on-board and off-board control unit or units. The control unit 40 may be configured to control the power assembly 20 by issuing control signals and by receiving status information relating to the power assembly 20. For example, the control unit 40 may be configured to control the fuel cell systems 30 by issuing control signals and by receiving status information relating to the fuel cell systems 30. The control unit 40 may also be configured to receive information from various sensors, including one or more of temperature sensors, moisture sensors, and other sensors included in or associated with the vehicle 10. For example, a temperature sensor may be positioned such that it can measure an ambient temperature (i.e. a temperature outside and/or in the vicinity of the vehicle) that reflects a temperature to which the fuel cell systems 30 are subjected. The control unit 40 may also be communicatively coupled to an internal database, an external database, or a combination thereof, to receive historical data related to driver's driving pattern and other events, data on auxiliary devices of the vehicle 10, historical data on usage of the auxiliary devices, data on a current location of the vehicle 10, current and predicted ambient conditions, historical data on ambient conditions at the current location, etc. The current location of the vehicle may be determined using, e.g., a global positioning system (GPS) tracking device associated with the vehicle. Information on past, current, and/or predicted ambient conditions may be received, e.g., from an external weather service.

The control unit 40 may receive data on driver input, data from a predictive weather service, and other types of data. The control unit 40 may form part of the power assembly 20, as shown in FIG. 1. In some implementations, the control unit 40 may be separate from the power assembly 20.

The control unit 40 is an electronic control unit and may comprise processing circuitry which is adapted to run a computer program as disclosed herein. The control unit 40 may comprise hardware and/or software for performing the method according to embodiments of the present disclosure. The control unit 40 may be denoted a computer. The control unit 40 may be constituted by one or more separate sub-control units. In addition, the control unit 40 may communicate by use of wired and/or wireless communication means.

The power assembly 20 further comprises an electrical storage system (ESS) 50, which may in turn comprise one or more batteries for storing excess electric energy produced by the at least one fuel cell system 30, and for providing output power from the power assembly 20. The ESS 50 is electrically connected to the fuel cell system 30. The ESS 50 may comprise its own control system, communicatively connected to the control unit 40. The ESS 50 may further be used for storing energy regenerated during braking, or it may be configured for charging by a charger, such as, e.g., from an external power grid.

The power assembly 20 may further comprise power electronics (not shown) for converting electric power generated by the fuel cell systems 30 and/or provided from the ESS 50 to electric power usable by a power consumer, such as an electric motor or another power consumer. Further, additionally or alternatively to what is mentioned in the above, the power assembly 20 may comprise various components such as compressors, sensors, pumps, valves, and electrical components.

Although the present disclosure is described with respect to a vehicle such as a truck, aspects of the present disclosure are not restricted to this particular vehicle, but may also be used in other vehicles such as passenger cars, off-road vehicles, aircrafts and marine vehicles. The present disclosure may also be applied in vessels and in stationary applications, such as in grid-connected supplemental power generators or in grid-independent power generators.

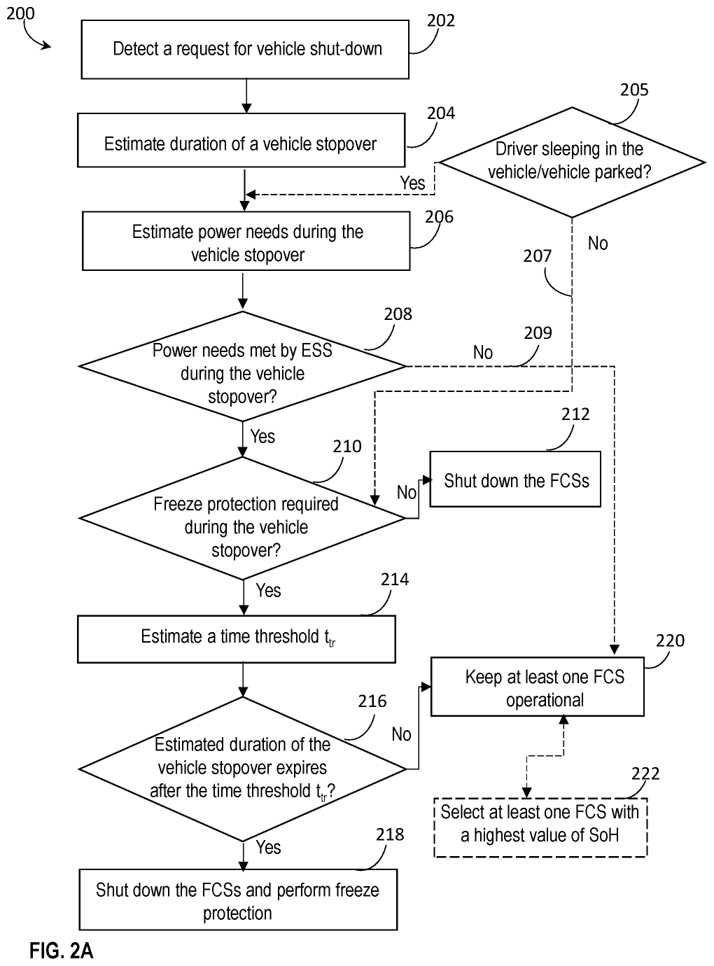

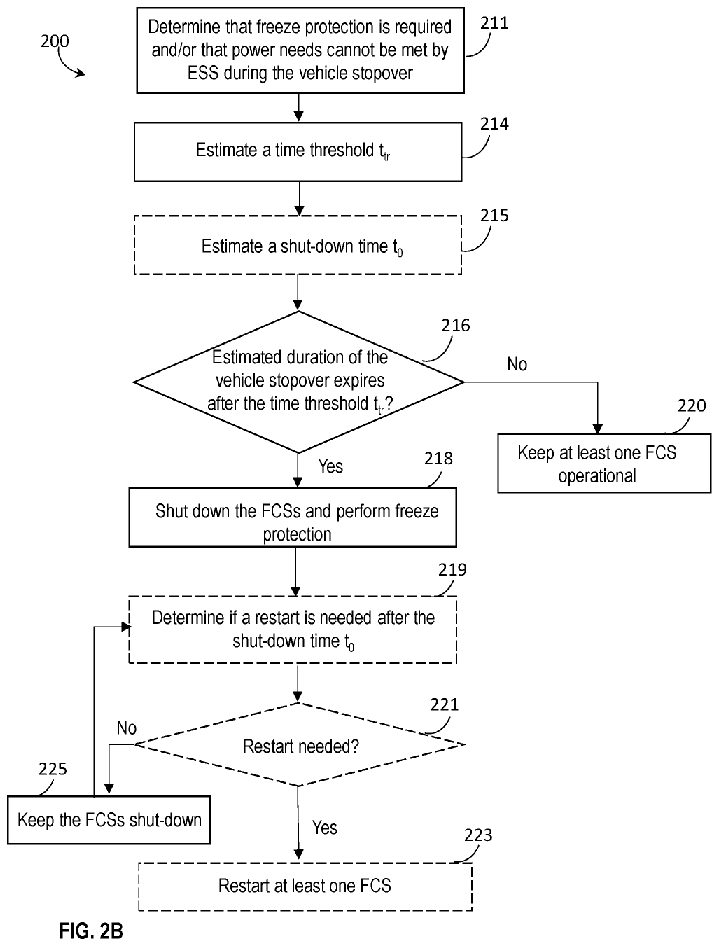

FIGS. 2A and 2B are flow charts of a method 200 for controlling a power assembly of a vehicle comprising a plurality of fuel cell systems and an electric energy storage system, according to an example. A power assembly may be, e.g., power assembly 20 of vehicle 10 shown in FIG. 1, and the method 200 is described below in connection with a vehicle such as vehicle 10 of FIG. 1. The method 200 may be implemented by a controller, such as, e.g., control unit 40 of FIG. 1.

The order of actions, associated with the blocks, in FIGS. 2A and 2B is shown by way of example only, as the actions or steps may be performed in other orders. Optional actions are shown with dashed lines.

As shown in FIG. 2A, the method 200 may begin when a request for a vehicle shut-down is received, at block 202. For example, the vehicle may be shut down during a stop or parking, collectively referred to herein as a stopover. During the vehicle stopover, it is herein assumed that the vehicle's engine is turned off. When the vehicle is stopped, the one or more fuel cell systems of the vehicle may initially remain to be turned on. At certain points in time, one or more of the plurality of the fuel cell systems may be turned off or turned on (e.g., turned back on or restarted) during the vehicle stopover. In some cases, one or more of the plurality of the fuel cell systems may be turned on, whereas other of the plurality of the fuel cell systems may be turned off.

When the request for a vehicle shut-down is received at block 202, and the vehicle is shut-down, the fuel cell systems of the vehicle may be operating until and if the method according to an example of the present disclosure determines that the fuel cell systems are to be shut down as well. The vehicle is thus stopped.

At block 204, a duration of the vehicle stop or stopover is determined or estimated. The duration of the stopover, during which the vehicle is shut-down, may be determined or estimated based on driver input, historical data related to the vehicle, e.g., historical data related to vehicle's driving pattern and other events (e.g., as recorded in vehicle log data), data on a current location of the vehicle, current and predicted ambient conditions, a time of the day, and based on other data. For example, input on a duration of the vehicle stopover may be received from a driver via an input device in the vehicle or capable of communicating with the vehicle, the input indicating for how long the vehicle stopover is expected. The input device may be, e.g., provided by a display device that can receive input, such as, e.g., a touch input, keyboard input, voice input, input from various other input devices, etc.) from a user such as the driver. The display device may be located in various locations of the vehicle, e.g., on a dashboard or center console. In some embodiments, the display device may be a display of a mobile device of a user such as the driver, and driver input received via such display device may be received remotely, while the driver is not necessarily in proximity to the vehicle. Any other type of device may be used to receive an input from a driver, or other person, regarding a duration of the vehicle stop or stopover.

The historical data may indicate that the vehicle is used for a certain mission at certain times of the day, while at other times (e.g., at night) the vehicle is parked. As another example, it may be known that, at the current location, the vehicle is typically parked for a certain amount of time. Also, depending on a type of the vehicle (e.g., a taxi, a public transportation vehicle, a long haul vehicle, etc.), the vehicle may experience different start-stop patterns that may be predicted based on previous use of the vehicle and previously logged data. As another factor, in some cases, driver shifts and laws stating how long drivers can be on the road and/or for how long they are required to take breaks may be taken into consideration in determining a time and duration of a vehicle stopover, which may be different for different vehicle types. For example, in some cases, the driver may be instructed to make a stop for a certain duration of time, e.g., for a mandatory break.

Regardless of the specific scenario, it is estimated for how long the vehicle is expected to be shut down.

At block 206, it is determined, using at least the estimated duration of the vehicle stopover, whether there are power needs from the vehicle during the vehicle stopover, e.g., while the vehicle is parked. The power needs for a duration of the vehicle stopover may include power needs for PTO devices coupled to the vehicle, such as, e.g., a crane, a refrigerator, an air conditioner, a heater, etc. The power needs may additionally be estimated using ambient conditions, information on vehicle auxiliary devices that are turned on, historical data on usage of the vehicle auxiliary devices, and using other data. For example, the power needs may increase when the ambient conditions include lower, e.g., sub-zero, ambient temperatures, which may be current and/or predicted temperatures. Non-limiting examples of auxiliary devices include an auxiliary battery, a mobile air conditioning system, an electric window lift, a heating system, a crane (e.g., a hydraulic crane), etc.

In some embodiments, determining, at block 206, whether there are power needs from the vehicle during the vehicle stopover comprises determining whether a driver of the vehicle is sleeping in the vehicle during the vehicle stopover, and/or whether the vehicle is parked. The vehicle may be, e.g., a taxi or another ride-sharing vehicle, and a driver of that vehicle may be sleeping in it at certain time. As another example, the vehicle may be a sleeper truck or tractor, e.g., a long-haul truck. The vehicle may also be a heavy-duty vehicle, e.g., performing a mission, and a driver of the heavy-duty vehicle may be sleeping in that vehicle during stops and/or overnight. In should be appreciated that sleeping may include resting or other status during a stopover of the vehicle at which the engine is shut down. A cabin of the vehicle may be heated or cooled during the stopover if the driver is inside the vehicle.

Thus, FIG. 2A includes a decision block 205 at which it is determined whether the driver is sleeping in the vehicle and/or whether the vehicle is parked, which may be a situation when certain energy/power needs are to be met during the vehicle stopover. In an example, whether or not the driver is sleeping in the vehicle may be determined using historical data on driver behaviour, information about a mission of the vehicle, operation of certain auxiliary devices, sensor information (e.g., using one or more sensors monitoring driver's behavior and status) and other information. If it is determined, at block 205, that the driver is sleeping in the vehicle and/or whether the vehicle is parked, the method 200 continues to block 206 where it is determined whether there are power needs from the vehicle during the vehicle stopover. The power needs from the vehicle may include power needs from its PTO devices. Although the processing at decision block 205 is shown as a separate step, it may be part of the processing at block 206.

At decision block 208, it may be determined whether the power needs can be met by an ESS during the vehicle stopover. In other words, it may be determined whether the ESS, such as, e.g., ESS 50 of FIG. 1, is capable of fulfilling the power needs of the vehicle and/or PTO devices during the vehicle stopover.

If it is determined, at decision block 208, that the estimated power needs can be met by the ESS during the vehicle stopover, the method 200 follows to decision block 210 where it is determined whether a freeze protection is required during the vehicle stopover. In some embodiments, whether the freeze protection is required during the vehicle stopover is determined when it is determined that there are power needs from the vehicle during the vehicle stopover and the power needs can be met or fulfilled by the electric energy storage system during the vehicle stopover.

In some embodiments, whether the freeze protection is required during the vehicle stopover may be determined, at decision block 210, when it is determined that there are no power needs from the vehicle during the vehicle stopover. This may occur, e.g., as shown in FIG. 2A, when the driver is not located in the vehicle during the stopover—e.g., when the driver is not sleeping or does not otherwise occupy the vehicle during the stopover. In other words, this may occur, as shown by a dashed arrow 207, when it is determined, at decision block 205, that the driver is not sleeping in the vehicle and/or the vehicle is not parked.

In some embodiments, whether the freeze protection is required during the vehicle stopover may be determined using current ambient conditions and predicted ambient conditions. For example, if it is expected that an ambient temperature (e.g., a temperature in the outside or other environment in which the vehicle is located) falls below 0° C. during the vehicle stopover, it may be determined that the freeze protection is required. The predicted ambient conditions may be received, e.g., from predicted weather services. Similarly, current ambient temperature, which may be determined using, e.g., one or more sensors, may be used in determining whether it is required to enable the freeze protection for the fuel cell system.

In some embodiments, whether the freeze protection is required during the vehicle stopover may be determined using a thermal model of the fuel cell system and evaluating a heat loss to the surrounding environment, which is a function of an ambient temperature. The thermal model may be, for example, a validated, one-dimensional or multi-dimensional thermal model calculating individual fuel cell temperatures. A need for freeze protection may then be evaluated by determined end-cell temperatures within the fuel cell stacks, i.e., the temperatures of individual fuel cells at the endplates of the fuel cell stacks, which may reach freezing temperatures sooner than other cells within the fuel cell systems. Alternatively, a lumped stack model may be used and a mass-average fuel cell stack temperature may be determined to evaluate a need for freeze protection. The model used may, for example, operate based on an ambient temperature input from a predictive weather service, a measured ambient temperature input taken from a temperature sensor external to the fuel cell system, or a measured temperature input taken from a temperature sensor internal to the fuel cell system, e.g., within the coolant loop. In some cases, the thermal model may be generated as described in, e.g., Henao, N., et al. (“PEMFC low temperature startup for electric vehicle,” IECON 2012-38th Annual Conference on IEEE Industrial Electronics Society, 2012, pp. 2977-2982), Amamou, A., et al. (“Thermal Management Strategies for Cold Start of Automotive PEMFC,” 2015 IEEE Vehicle Power and

Propulsion Conference (VPPC), 2015, pp. 1-6), and Khandelwal, M., et al. (“One-dimensional thermal model of cold-start in a polymer electrolyte fuel cell stack,” Journal of Power Sources, 2007, vol. 172, pp. 816-830). In Henao, N., et al. (2012), an energy management strategy using a lumped mass fuel cell stack thermal model is proposed and experimentally validated. The strategy estimates the ideal time to begin heating a fuel cell stack during a cold start operation assuming a known initial fuel cell temperature. A similar lumped model can be used to also estimate the time at which the fuel cell stack would reach a critical temperature, as is done, e.g., in Amamou, A., et al. (2015), where such a model is created to compare cold start strategies. In certain implementations, a model as described in Khandelwal, M., et al. (2007), which simulates individual cell behavior in a one-dimensional transient model, may be used.

If it is determined, at decision block 210, that the freeze protection is not required, the fuel cell systems may be shut down, without enabling the freeze protection, at block 212. The freeze protection may not be required when the power needs of the vehicle and/or of its auxiliary, e.g., PTO devices, can be met by an electrical energy storage. In some embodiments, the freeze protection may not be required if there are no power needs from the vehicle and/or of its auxiliary, e.g., PTO, devices during the vehicle stopover. The freeze protection may also not be required, for example, if the ambient temperature is not expected to fall below 0° C., or if it is expected to fall below 0° C. for a time period that is not expected to create a risk of the fuel cell system freezing.

If it is determined, at decision block 210, that the freeze protection is required, the method 200 follows to estimating, at block 214, a threshold time tₜᵣ indicating a time after which a cost of keeping the fuel cell systems operational outweighs a cost of shutting down the fuel cell systems. This can also be referred to as a breakeven point between the so called “keep-warm” and “thaw-at-start” cold start strategies. When the fuel cell system is turned off, it does not provide any output power and does not consume any fuel. When the fuel cell unit is turned on, it consumes fuel, such as hydrogen (H₂), and it supplies output power that may be stored in the electric energy storage system. The cost associated with fuel cell consumption therefore arises when the fuel cell system is kept operational. At the same time, the cost also arises when the fuel cell system is shut down, since in this case the risk of freezing of the fuel cell system increases. The power stored in the electric energy storage system is consumed to perform the freeze protection and then later to thaw the fuel cell system and bring it to a suitable temperature before starting it up. The vehicle may be heated using an electric heating component, and/or any other heating device that is available on board the vehicle or accessible to the vehicle. For example, a hydrogen heater, such as a catalytic heater, may be used in which case costs will be different. Also, if an external electricity source is used, costs will be different.

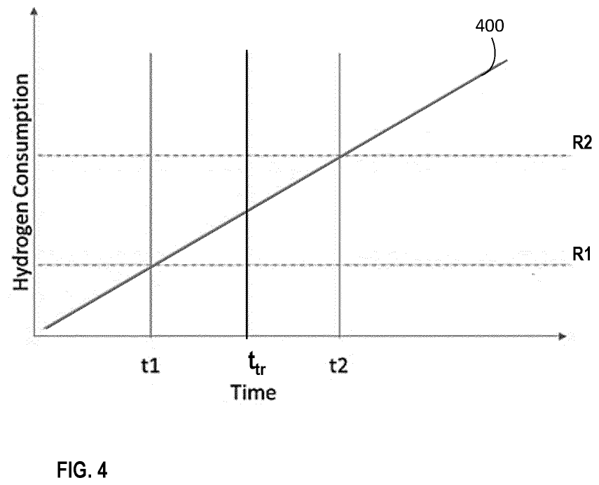

The threshold time tₜᵣ may be estimated using a first threshold time and a second threshold time, wherein the first threshold time may be calculated for a case or a scenario in which the electric energy storage system is not capable of storing any of the power generated by the fuel cell systems during the vehicle stopover, and the second threshold time may be calculated for a case or a scenario in which the electric energy storage system is capable of storing the entirety of power generated by the fuel cell systems during the vehicle stopover. The first and second threshold times may be determined by using information on initial state of charge (SoC) and capacity of the electric energy storage system such as batteries. For example, the first threshold time may be calculated for a scenario in which the SoC is 100% at the beginning of the stopover period, and the second threshold time may be calculated for a scenario in which the SoC is 0% at the beginning of the stopover period. See the description of FIG. 4 presented later for more details on the calculation of tₜᵣ.

Next, it is determined, at decision block 216, whether the estimated duration of the vehicle stopover expires after the threshold time tₜᵣ. Thus, it is determined at block 216 whether the estimated duration of the vehicle stopover is longer than a time period upon expiration of which the cost of keeping the fuel cell systems operational outweighs the cost of shutting down the fuel cell systems. In other words, after the threshold time tₜᵣ expires, it becomes more costly to keep one or more of the fuel cell systems operational than shutting down the fuel cell systems.

If the estimated duration of the vehicle stopover expires after the threshold time tₜᵣ, at block 218, the method 200 includes shutting down the fuel cell systems and enabling the freeze protection. In addition, in some cases, if the estimated duration of the vehicle stopover is equal to the threshold time tₜᵣ, the method 200 may similarly include shutting down the fuel cell systems and enabling the freeze protection.

The freeze protection may include using an external heater, an antifreeze solution, purging of water before shutdown, and other techniques. A specific freeze protection method may depend on characteristics of the power assembly, fuel cell system(s), and other factors.

In some embodiments, enabling the freeze protection comprises selecting a freeze protection method, which is a method appropriate for the fuel cell systems.

If the estimated duration of the vehicle stopover expires before the threshold time, the method 200 includes keeping at least one of the fuel cell systems operational, as shown at block 220. In some embodiments, if it is determined that there are power needs from the vehicle during the vehicle stopover and the power needs cannot be fulfilled by the electric energy storage system during the vehicle stopover (as shown by an arrow 209 in FIG. 2A), the method 200 similarly follows to block 220 where it comprises keeping at least one fuel cell system of the fuel cell systems operational. The at least one fuel cell system of the fuel cell systems may be kept operational to keep the rest of the fuel cell systems warm to thereby prevent freezing.

In some embodiments, keeping the at least one fuel cell system of the plurality of fuel cell systems of the vehicle operational includes determining which of the fuel cell systems to keep operational. A state of health of each of the fuel cell systems of the vehicle may be used for this purpose. Thus, the at least one fuel cell system may be selected, at block 222, by comparing values each representing a state of health of a respective fuel cell system of the plurality of fuel cell systems, wherein the at least one fuel cell system has a highest value representing the state of health of the at least one fuel cell system. Accordingly, the at least one fuel cell system is selected that has a highest value representing its state of health (SoH).

A value representing a SoH (or a value of a SoH) of a fuel cell system may be determined in multiple ways. For example, a polarization curve of the fuel cell system may be evaluated. A polarization curve, which displays the voltage output of the fuel cell system for a given current density loading, may be used in analyzing a fuel cell degradation process. As the fuel cell system ages, the polarization curve of the fuel cell system changes. Thus, as the fuel cell system ages, for the same current, the voltage goes down and this can give an indication of a value of a SoH of the fuel cell system.

Also, in some examples, numerical techniques and/or machine learning may be used to estimate or predict a value of a SoH of a fuel cell system, using data on conditions in which the fuel cell system have operated. For example, a history of operating conditions of the fuel cell system may be used to predict a value of a SoH of the fuel cell systems.

FIG. 2B is another flow chart of the method 200 of FIG. 2A for controlling a power assembly comprising a plurality of fuel cell systems and an electric energy storage system, according to one example. FIG. 2B illustrates in more detail calculation and use of a threshold time tr in accordance with aspects of the present disclosure.

As shown in FIG. 2B, the method 200 may determine, at block 211, that the freeze protection is required and/or that the power needs cannot be met by the ESS during the vehicle stopover. For example, the “Yes” arrow coming out of the decision block 210 in FIG. 2A denotes a situation when it is determined that the freeze protection is required.

In some embodiments, if the freeze protection is required, time periods tₜᵣ (threshold time) and to (initial shutdown time) may be calculated or estimated, at blocks 214 and 215 of FIG. 2B, respectively. A crossover point, after which it is more cost-efficient to shut down the fuel cell systems and perform the freeze protection rather than keeping the fuel cell systems operational, is represented by tₜᵣ. If the vehicle stopover duration is greater than tₜᵣ, then the fuel cell systems are shut down and freeze protection is enabled. If the vehicle stopover duration is less than tₜᵣ, then at least one fuel cell system may be kept operational to keep the other fuel cell systems warm to prevent freezing.

In embodiments of the present disclosure, the estimation of tₜᵣ and t₀ may be done based on comparing the cost of the hydrogen consumption that will be incurred if the fuel cell systems are kept operational (including the degradation cost for keeping the fuel cell systems operational) with expected degradation cost that will occur if the freeze protection is done. The fuel cell systems are restarted when the vehicle needs to be moved.

FIG. 4 is a graph 400 illustrating calculation of a threshold time tₜᵣ when the vehicle does not have any energy/power needs during the vehicle stopover. The graph 400 is shown as hydrogen consumption by the fuel cell systems, as a function of time. The threshold time tₜᵣ may be estimated using a first threshold time t1 and a second threshold time t2. The first threshold time t1 may be calculated for a scenario in which the electric energy storage system is not capable of storing any of the power generated by the fuel cell systems during the vehicle stopover, and the second threshold time t2 may be calculated for a scenario in which the electric energy storage system is capable of storing the entirety of power generated by the fuel cell systems during the vehicle stopover. As shown in FIG. 4, the threshold time tₜᵣ lies between the first threshold time t1 and the second threshold time t2. The first and second threshold times t1 and t2 are the two extremes calculated, respectively, based on scenarios where the ESS, e.g., the battery, cannot take or store any power generated from the fuel cell system(s) (i.e., the ESS cannot be charged) and where the ESS is capable of taking or storing all or the entirety of the power generated from the fuel cell systems during the stopover/vehicle parked duration. When the battery cannot take any further power, the power may be dissipated, e.g., to heat up a cabin space of the vehicle or in other ways, e.g., via a brake resistor that can dissipate excess energy.

Costs thresholds R1 and R2 for calculating the first and second threshold times t1 and t2 are shown by the horizontal lines in FIG. 4. R1 denotes an acceptable threshold for a situation in which the ESS cannot store any power generated from the fuel cell system(s), i.e., the ESS cannot be charged, whereas R2 denotes an acceptable threshold for a situation in which the ESS can store all power coming from the fuel cell system to charge. The rationale behind this is that if the ESS, such as batteries, can be charged with the power generated from the fuel cell systems, then a higher cost of hydrogen consumption can be accepted to keep the systems operational as this is compensated by the charged batteries when the vehicle needs to move next time.

The R1 threshold used for when the batteries cannot be charged may be determined using an amount of energy required for freeze preparation and thawing of the fuel cell system(s) after freezing. Also, the degradations due to start up and purging are taken into consideration to calculate the R1 threshold.

Depending on the state of the charge of the ESS at the time of the vehicle parking, the threshold time tₜᵣ may lie between the first and second threshold times t1 and t2. Thus, FIG. 4 shows the threshold time tₜᵣ lying between t1 and t2, and its position relative to the first and second threshold times t1 and t2 may vary depending on the state of the charge of the ESS such as batteries at the initial time of parking. For example, if the batteries are empty or close to empty, the threshold time tₜᵣ may be close to the second threshold time t2. As another example, if the batteries are full, then the threshold time tₜᵣ may be close to the first threshold time t1. The shape of the hydrogen consumption line or graph may be considered to be linear, assuming that the fuel cell systems are running or operating at a constant power level. However, the slope of the hydrogen consumption graph and also the shape of the graph (e.g., a curve) may change depending on the ambient conditions and fuel cell system(s) operation.

In some cases, the threshold time tₜᵣ may be referred as a time period which extends from a time when the vehicle is shut down for a stopover until the expiration of the threshold time tₜᵣ. FIG. 4 shows that the graph 400, in the form of a straight line graph, passes through the points (t1, R1) and (t2, R2). A point in which the graph 400 intersects a vertical line (parallel to the y-axis) passing through the threshold time tₜᵣ is a time point at which it may be as equally cost-efficient to shut down the fuel cell systems and perform the freeze protection as it is to keep the fuel cell systems operational. However, at a time point after the threshold time tₜᵣ, it may be more cost-efficient to shut down the fuel cell systems and perform the freeze protection, rather than keeping the fuel cell systems operational. Similarly, at a time point before the threshold time tₜᵣ, it may be less cost-efficient to shut down the fuel cell systems and perform the freeze protection, as compared to keeping the fuel cell systems operational.

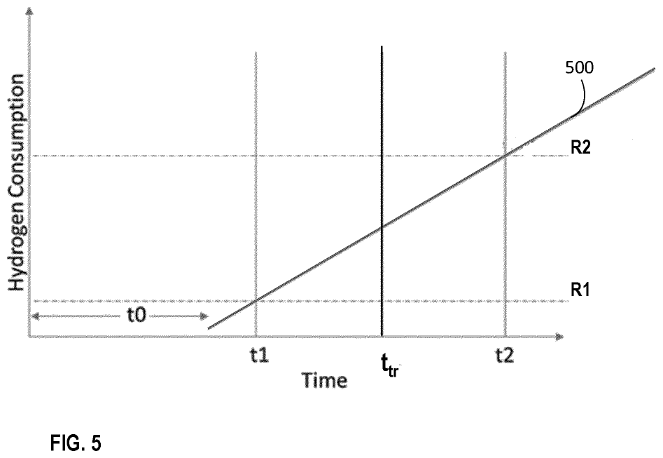

In some embodiments, the at least one fuel cell system of the power assembly of the vehicle may be restarted after a certain time period during which the plurality of fuel cell systems are shut down. The certain time period may be denoted as to, which may be determined, e.g., at block 215 of FIG. 2B. Thus, the fuel cell systems of the power assembly of the vehicle may be restarted before an ambient temperature lowers to the point that freezing may occur, or they may be restarted before the fuel cell systems themselves reach freezing temperatures. This can be, e.g., in the case when the ambient temperature around a parked vehicle is high during the day, e.g., above 0° C. (e.g., at least 5° C., or another temperature above zero) but it drops below freezing during the night. This case is shown in FIG. 5, which is another graph 500 illustrating calculation of a threshold time tₜᵣ when the vehicle does not have any energy/power needs during the vehicle stopover. The graph 500 is shown as hydrogen consumption by the fuel cell systems, as a function of time.

In the example shown in FIG. 5, an additional time tₜᵣ is also included in the calculation of the threshold time tₜᵣ. This time to denotes the time during which the fuel cell system(s) are shut down. At the time t₀, the fuel cell system(s), which were previously shut down, are restarted, and the hydrogen consumption cost starts to increase after this time t₀. The other calculations of the first and second threshold times t1 and t2, as well as R1 and R2, are the same as in the example of FIG. 4. However, in the example of FIG. 5, the thresholds R1 and R2 for calculation of t1 and t2 may be lower than in the example of FIG. 4, so as to take into account increased degradation that may occur due to the restart of the fuel cell system(s).

FIG. 5 shows that the straight line graph 500 passes through the points (t1, R1) and (t2, R2). A point in which the graph 500 intersects a vertical line (parallel to the y-axis) passing through the threshold time tₜᵣ is a time point at which it may be as equally cost-efficient to shut down the fuel cell systems and perform the freeze protection as it is to keep the fuel cell systems operational. However, at a time point after the threshold time ter, it may be more cost-efficient to shut down the fuel cell systems and perform the freeze protection, rather than keeping the fuel cell systems operational.

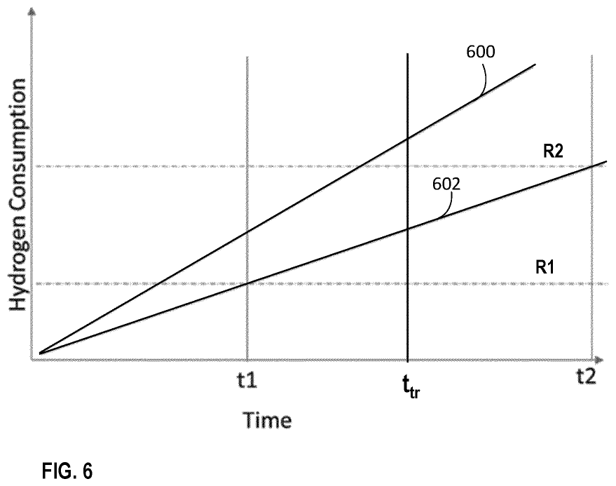

FIG. 6 illustrates first and second graphs 600 and 602 used for calculation of a threshold time tₜᵣ when the vehicle has energy/power needs during the stopover of the vehicle. The first and second graphs 600 and 602 are each shown as hydrogen consumption by the fuel cell system(s) as a function of time. More specifically, both graphs represent hydrogen consumed for the purpose of keeping the system warm and preventing freezing. Heat is a byproduct of power generation in a fuel cell system, and, for a certain amount of power generated, a certain amount of heat is also generated. This heat can be used to keep the systems warm. The graph 600 illustrates a situation where there are no power needs and graph 602 represents a situation where there are power needs. If the vehicle has power needs which are being fulfilled by the fuel cell systems, then the cost of hydrogen consumption over time to keep a fuel cell system operational to prevent freezing may be lower. The rationale is that some of the hydrogen consumption is accounted for with the fulfillment of the vehicle energy and power needs.

As shown in FIG. 6, it may be assumed, for example, that the fuel cell system, while providing a certain first amount of power (e.g., 10 kW), consumes the hydrogen according to the first line graph 600. However, a certain second amount of power (e.g., 5 kW, which is not explicitly shown in FIG. 6) may be required to fulfill the vehicle power needs, such that the actual rate of hydrogen consumed solely for freeze prevention is considered as only a portion of the total hydrogen consumption. Using the example values and given that the first amount of power is greater than the second, the power consumed towards freeze protection can be considered as the remaining power, i.e., the first amount of power minus the second amount of power (10 kW−5 kW=5 kW for freeze protection, in this example). If the power needs of the vehicle (e.g., when a driver is sleeping in the vehicle or when there are power take-off needs) are greater than what the fuel cell system requires to keep itself warm (e.g., the second amount of power is 15 kW rather than 5 kW), then the vehicle power/energy needs may be considered to be greater than the first amount of power represented in graph 600. In this case, continuing with the present example, the second line graph 602 may coincide with the x-axis and the fuel cell system will be operational to fulfill the power/energy needs of the vehicle without having any additional cost for freeze prevention (e.g., 10 kW−15 kW<0 kW, therefore additional power needed for freeze protection is 0 kW). In this case, i.e. when the fuel cell system is running to fulfill the power needs of the vehicle, the heat to warm the system(s) is being generated as a byproduct, which may be referred to as a free net generation, i.e. without an additional cost. The hydrogen consumption solely towards heating the fuel cell system will thus be zero. This will result in the second line graph 602 coinciding with the x-axis, as the additional hydrogen consumption for freeze protection is zero. However, it should be noted that the hydrogen consumption itself is not zero in this case, but the hydrogen consumption towards heating the fuel cell system is zero.

FIG. 6 shows that the straight line graph 602 passes through the points (t1, R1) and (t2, R2). A point in which the graph 602 intersects a vertical line (parallel to the y-axis) passing through the threshold time tₜᵣ is a time point after which it may be as equally cost-efficient to shut down the fuel cell systems and perform the freeze protection as it is to keep the fuel cell systems operational. However, at a time point after the threshold time tₜᵣ, it may be more cost efficient to shut down the fuel cell systems and perform the freeze protection, rather than keeping the fuel cell systems operational.

Referring back to FIG. 2B, similar to the processing shown in FIG. 2A, it is determined, at decision block 216, whether the estimated duration of the vehicle stopover expires after the threshold time tr. If this is the case, at block 218, the method 200 includes shutting down the fuel cell systems and enabling the freeze protection. In some embodiments, enabling and performing the freeze protection comprises selecting a freeze protection method, which is a method appropriate for the fuel cell systems.

If the estimated duration of the vehicle stopover expires before the threshold time tr, the method 200 may include (1) keeping at least one fuel cell system of the fuel cell systems operational, or (2) restarting the at least one fuel cell system. The option of keeping the at least one of the fuel cell systems operational is shown at block 220, similarly to FIG. 2A. Alternatively, at block 219 of FIG. 2B, it may be determined whether a restart of the at least one fuel cell of the fuel cell systems is needed, after the time t₀. As further shown in FIG. 2B, the processing at block 219 may also be performed after the fuel cell systems have been shut down and the freeze protection was enabled, at block 218.

At decision block 221, it may be determined whether the restart of at least one fuel cell system of the plurality of fuel cell systems is needed after the time to. If it is determined that the restart of the at least one fuel cell system is needed, the at least one fuel cell system may be restarted, at block 223. Alternatively, if it is determined that the restart of the at least one fuel cell system is not needed, the fuel cell systems may be kept being shut down, at block 225.

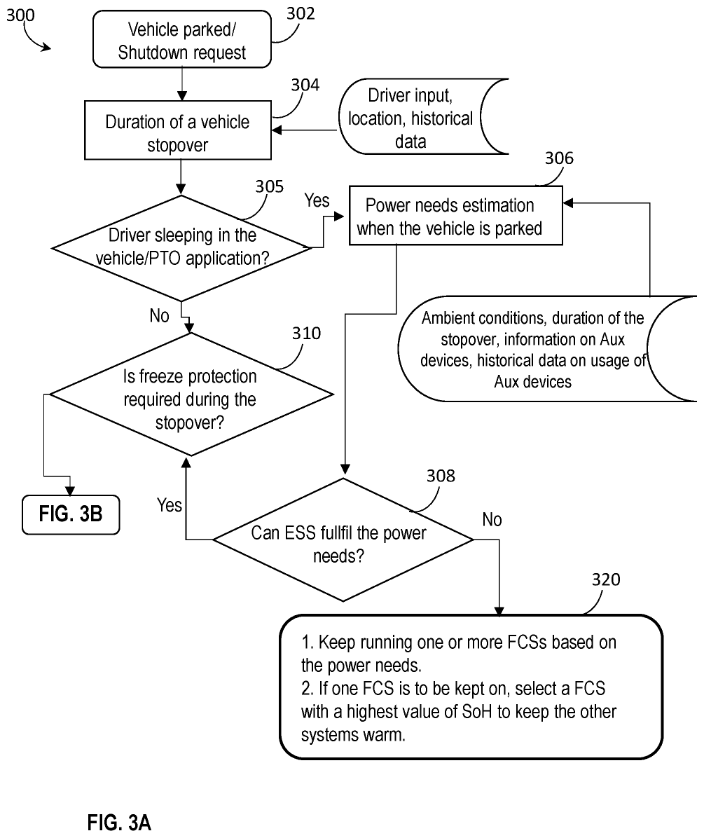

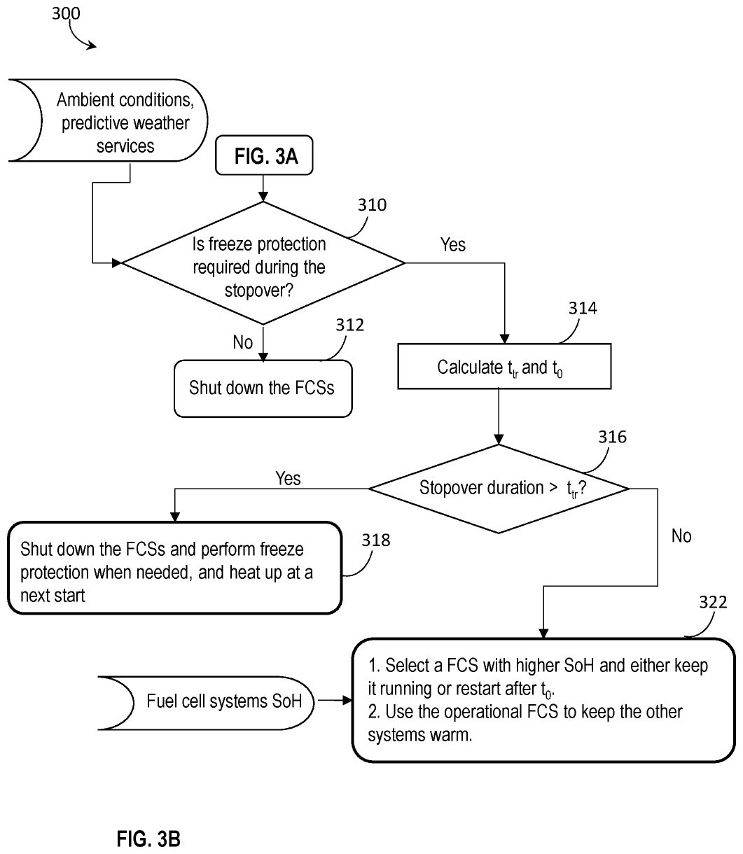

FIGS. 3A and 3B are flowcharts together illustrating another example of a method 300 for controlling a power assembly of the vehicle, comprising a plurality of fuel cell systems and an electric energy storage system. The method 300 of FIGS. 3A and 3B is similar to method 200 of FIGS. 2A and 2B. The method 300 may be performed by a controller unit, such as, e.g., the control unit 40 of FIG. 1.

The order of actions, associated with the blocks, in FIG. 3A and 3B is shown by way of example only, as the actions or steps may be performed in other orders. Also, although not indicated in FIGS. 3A and 3B, one or more of the actions may be optional.

In FIG. 3A, at block 302, a method 300 includes receiving a vehicle parked/shutdown request. For example, a driver may shut down the vehicle. If the vehicle is an autonomous or a semi-autonomous vehicle, the vehicle may be shut down automatically.

At block 304, a duration of the vehicle stopover, after the vehicle is shut down, is determined. This may be performed using at least a driver input, a location data e.g. global positioning system (GPS) location of the vehicle, and a historical data which may include historical data on the driver, operation of the vehicle, use of auxiliary devices of the vehicle, etc.

At decision block 305, it may be determined whether the driver is sleeping in the vehicle and/or whether there is any PTO application associated with the vehicle, such as a PTO device. If it is determined whether the driver is sleeping in the vehicle and/or there is a PTO application, energy/power needs (referred to herein as power needs) from the vehicle during the vehicle stopover, e.g., while the vehicle is parked, may further be determined, at block 306. The power needs for a duration of the vehicle stopover may include power needs for PTO devices connected to or installed on the vehicle, such as, e.g., a crane, a refrigerator, an air conditioner, a heater, etc. The power needs may be estimated using one or more of ambient conditions, duration of the vehicle stopover (as determined at block 304), information on vehicle auxiliary devices that are turned on, historical data on usage of the vehicle auxiliary devices, and using other data. Non-limiting examples of auxiliary devices include an auxiliary battery, a mobile air conditioning system, an electric window lift, a heating system, a crane (e.g., a hydraulic crane), etc.

After the power needs from the vehicle during the vehicle stopover are determined, the method 300 may continue to block 308 where it may be determined whether the power needs can be met or fulfilled by an ESS during the vehicle stopover. If it is determined that the power needs of the vehicle can be met by the ESS during the vehicle stopover, the method 300 may follow to block 310 where it is determined whether a freeze protection for the plurality of fuel cell system of the vehicle is required during the vehicle stopover. If however it is determined that the power needs of the vehicle cannot be met by the ESS during the vehicle stopover, the method 300 may follow to block 320 where the method 300 comprises (1) keeping running or operational one or more fuel cell systems of the plurality of fuel cell systems based on the power needs of the vehicle during the vehicle stopover, and (2) if one fuel cell system of the plurality of fuel cell systems is to be kept operational (or on), selecting a fuel cell system of the plurality of fuel cell systems with a highest value representing a state of health of a fuel cell system, to keep the other fuel cell systems warm.

As shown in FIG. 3A, the method 300 continues to be illustrated in FIG. 3B, after the decision block 310, which is shown again in FIG. 3B for clarity of illustration. As shown in FIG. 3B, the determination of whether the freeze protection for the plurality of fuel cell system of the vehicle is required during the vehicle stopover may be performed based on ambient conditions, which may be current or predicted conditions, e.g., using data obtained from predictive weather service(s).

If it is determined that the freeze protection is not required, the fuel cell systems may be shut shown, at block 312, and a freeze protection is not enabled.

If it is determined that the freeze protection is required, a threshold time tₜᵣ and a shutdown time to may be calculated, at block 314. These may also be calculated at separate steps, at shown in FIG. 2B (blocks 214 and 215). Next, it may be determined, at decision block 316, whether the estimated duration of the vehicle stopover is greater (i.e. expires after) the threshold time tₜᵣ. If this is the case, the method 300 includes shutting down the fuel cell systems and performing the freeze protection, at block 318. The fuel cell systems may then be heated up before or at their next start.

If it is determined, at decision block 316, that the estimated duration of the vehicle stopover is smaller (i.e. expires before) the threshold time tr, the method 300 may continue to block 322 where the method 300 comprises: (1) selecting a fuel cell system from the plurality of fuel cell systems that has a higher value of state of health (SoH) and either keeping it running/operational or restarting it after the time t₀, or (2) using the at least one fuel cell system from the plurality of fuel cell systems that is operational to keep the other fuel cell systems from the plurality of fuel cell systems warm. This processing may thus include using data on a state of health of the plurality of fuel cell systems of the power assembly of the vehicle, as shown in FIG. 3B.

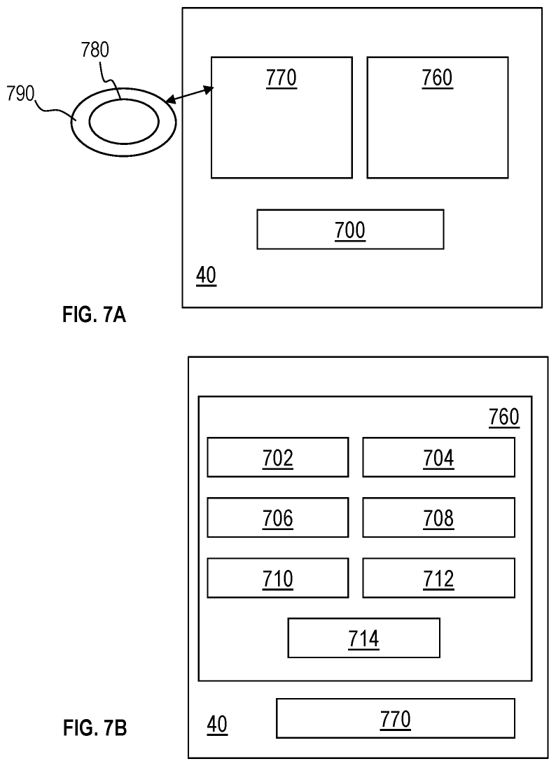

To perform the method steps described herein, the control unit 40 may be configured to perform the processing described in connection with FIGS. 2A, 2B, 3A, and 3B above, and/or any other examples or embodiments herein. The control unit 40 may, for example, comprise an arrangement as depicted in FIGS. 7A and 7B.

As shown in FIG. 7A, The control unit 40 may comprise an input and output interface 700 configured to communicate with any necessary components and/or entities of embodiments herein, e.g., to receive system states from the ESS 50, to receive location information, weather information, information on driver input, any type of historical data, information on at least one auxiliary device of the vehicle, information on use of the at least one auxiliary device of the vehicle, and any other information. The input and output interface 700 may comprise a wireless and/or wired receiver (not shown) and a wireless and/or wired transmitter (not shown). The input and output interface 700 may comprise a transmitter, a receiver, a transceiver and/or one or more antennas. The control unit 40 may be positioned in any suitable location of the vehicle 10. The control unit 40 may use the input and output interface 700 to control and communicate with sensors, actuators, subsystems, and interfaces in the vehicle 10 by using any one or more out of a Controller Area Network (CAN), ethernet cables, Wi-Fi, Bluetooth, and other network interfaces. The control unit 40 may be configured to communicate with one or more external services, databases, and/or controllers via wireless communication technologies.

The method described herein may be implemented through a processing circuitry, e.g., one or more processors, such as the processing circuitry 760 of the control unit 40 depicted in FIG. 7A, together with computer program code for performing the functions, actions, and steps of the embodiments herein. The computer program code may be provided as a computer program medium, for instance in the form of a computer-readable storage medium carrying computer program code or computer-executable instructions for performing the methods in accordance with embodiments of the present disclosure, when loaded into the control unit 40 and executed by the processing circuitry 760. An example of a computer-readable storage medium may be in the form of a memory stick or any other appropriate medium that can hold machine readable data. The computer program code may furthermore be provided as a program code on a server and downloaded to the control unit 40.

The control unit 40 may further comprise a memory 770 comprising one or more memory units. The memory 770 comprises instructions executable by the processing circuitry 760 of the control unit 40. The memory 770 is arranged to be used to store, e.g., information, data, etc., to perform the methods herein, when being executed in the control unit 40. The control unit 40 may additionally obtain information from an external memory.

In some embodiments, a computer program product 780 comprises instructions, e.g., software code portions, which, when executed on at least one processor, e.g., on the processing circuitry 760, cause the at least one processor to carry out the method steps described herein, as performed by the control unit 40.

In some embodiments, a computer-readable storage medium 790 stores the computer program product 780. The computer-readable storage medium 790 may be, e.g., a disc, a universal serial bus (USB) stick, or similar. The computer-readable storage medium 790 may store thereon the computer program product 780 that comprises program code or instructions which, when executed on at least one processor, e.g., the processing circuitry 760, cause the at least one processor to carry out the method according to embodiments herein.

As shown in FIG. 7B, the control unit 40 may comprise a receiving unit 702. The control unit 40, the processing circuitry 760, and/or the receiving unit 702 may be configured to receive or detect a request for vehicle shut-down.

The control unit 40 may further comprise an estimating unit 704. The control unit 40, the processing circuitry 760, and/or the estimating unit 704 may be configured to estimate a duration of a vehicle stopover of the vehicle. The duration of the vehicle stopover may be estimated using one or more of a driver input, location information, ambient information, and historical data related to operation of the vehicle.

The control unit 40 may further comprise a determining unit 706. The control unit 40, the processing circuitry 760, and/or the determining unit 706 may be configured to determine whether a freeze protection is required during the vehicle stopover. In some cases, whether the freeze protection is required during the vehicle stopover may be determined using current ambient conditions and predicted ambient conditions. In some implementations, the estimating unit 704 and the determining unit 706 may be part of the same unit.

The control unit 40 may further comprise a shutting down unit 708. The control unit 40, the processing circuitry 760, and/or the shutting down unit 708 may be configured, if it is determined that the freeze protection is not required, shutting down the fuel cell system without enabling the freeze protection. Thus, a freeze protection of the fuel cell systems is not performed when it is determined that the freeze protection is not required. However, the shutting down unit 708 of the control unit 40 may be capable of controlling the fuel cell system and/or other components of the power assembly or the vehicle in general, to perform the freeze protection of the fuel cell systems in situation when it is determined to be required.

The control unit 40, the processing circuitry 760, and/or the estimating unit 704 may further be configured to estimate a threshold time, such as a threshold time tₜᵣ, indicating a time at which a cost of keeping the fuel cell systems operational outweighs a cost of shutting down the fuel cell systems. The threshold time may be estimated using a first threshold time and a second threshold time. The first threshold time may be calculated for a case when the electric energy storage system is not capable of storing any of the power generated by the fuel cell systems during the vehicle stopover, and the second threshold time may be calculated for a case when the electric energy storage system is capable of storing the entirety of power generated by the fuel cell systems during the vehicle stopover.

The control unit 40, the processing circuitry 760, and/or the shutting down unit 708 may further be configured, if it is determined that the estimated duration of the vehicle stopover expires after the threshold time, shutting down the fuel cell systems and enabling the freeze protection.

The control unit 40 may further comprise a power estimation unit 710. The control unit 40, the processing circuitry 760, and/or the power estimation unit 710 may be configured to determine, using at least the estimated duration of the vehicle stopover, whether there are power needs from the vehicle during the vehicle stopover. Determining whether there are power needs from the vehicle during the vehicle stopover may comprise determining whether a driver of the vehicle is sleeping in the vehicle during the vehicle stopover and/or whether the vehicle is parked. The control unit 40, the processing circuitry 760, and/or the power estimation unit 710 may be configured to determine whether there are power needs from the vehicle during the vehicle stopover using various other information, such as, e.g., information on auxiliary devices of the vehicle, current and/or predicted ambient conditions, and other information.

The control unit 40, the processing circuitry 760, and/or the determining unit 706 may be configured to determine whether a freeze protection is required during the vehicle stopover, wherein whether the freeze protection is required during the vehicle stopover is determined when it is determined that there are no power needs from the vehicle during the vehicle stopover. In an embodiment, whether the freeze protection is required during the vehicle stopover is determined when it is determined that there are power needs from the vehicle during the vehicle stopover and the power needs can be fulfilled during the vehicle stopover.

The control unit 40 may further comprise a fuel cell system controlling unit 712. The control unit 40, the processing circuitry 760, and/or the fuel cell system controlling unit 712 may be configured to, if it is determined, by the control unit 40, the processing circuitry 760, and/or the power estimation unit 710, that there are power needs from the vehicle during the vehicle stopover and the power needs cannot be fulfilled during the vehicle stopover, keeping at least one fuel cell system of the fuel cell systems operational.

The control unit 40, the processing circuitry 760, and/or the fuel cell system controlling unit 712 may be configured to, if the estimated duration of the vehicle stopover expires before the threshold time tₜᵣ, (1) keeping at least one fuel cell system of the fuel cell systems operational, or (2) restarting the at least one fuel cell system.

In certain example, the at least one fuel cell system may be restarted after a certain time period during which the plurality of fuel cell systems are shut down. The control unit 40, the processing circuitry 760, and/or the fuel cell system controlling unit 712 may be configured to restart the plurality of fuel cell systems.

The control unit 40 may further comprise a selecting unit 714. The control unit 40, the processing circuitry 760, and/or the selecting unit 714 may be configured to select the at least one fuel cell system by comparing values each representing a state of health of a respective fuel cell system of the plurality of fuel cell systems, wherein the at least one fuel cell system has a highest value representing the state of health of the at least one fuel cell system. The at least one fuel cell system may be selected to be kept operational, or the at least one fuel cell system may be selected to be restarted, e.g., to keep the other fuel cell systems warm. In certain examples, the at least one fuel cell system may be selected to be restarted after a certain time period during which the plurality of fuel cell systems are shut down. The fuel cell system may be selected from two or more fuel cell systems. If the vehicle includes one fuel cell system, that fuel cell system is selected.

The units of the control unit 40 may be executed by the processing circuitry 760, as shown in FIG. 7A. It should be appreciated that the units of the control unit 40 are shown as an example, since one or more of the units may be part of the same unit, or one or more of the units may have sub-units. For example, in some embodiments, the fuel cell system controlling unit 712 and the shutting down unit 708 may be part of the same unit of the controller 40. Also, one or more of the fuel cell system controlling unit 712, the shutting down unit 708, and the selecting unit 714 may be part of the same unit. In some embodiments, one or more of the estimating unit 704, the determining unit 706, and the power estimation unit 710 may be part of the same unit.

Those skilled in the art will appreciate that the units in the control unit 40 described above may refer to a combination of analogue and digital circuits, and/or one or more processors configured with software and/or firmware, e.g., stored in the control unit 40, that, when executed by the respective one or more processors, may perform the methods in accordance with embodiments of the present disclosure. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip.

The operational steps described in any of the exemplary aspects herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A computer-implemented method of controlling a power assembly of a vehicle comprising a plurality of fuel cell systems and an electric energy storage system, the method comprising:
estimating a duration of a vehicle stopover of the vehicle;
determining whether a freeze protection is required during the vehicle stopover; and
if it is determined that the freeze protection is not required, shutting down the fuel cell system without enabling the freeze protection.

2. The method of claim 1, further comprising:
if it is determined that the freeze protection is required, estimating a threshold time indicating a time at which a cost of keeping the fuel cell systems operational outweighs a cost of shutting down the fuel cell systems; and
if the estimated duration of the vehicle stopover expires after the threshold time, shutting down the fuel cell systems and enabling the freeze protection.

3. The method of claim 2, further comprising:
determining, using at least the estimated duration of the vehicle stopover, whether there are power needs from the vehicle during the vehicle stopover.

4. The method of claim 3, wherein determining whether there are power needs from the vehicle during the vehicle stopover comprises determining whether a driver of the vehicle is sleeping in the vehicle during the vehicle stopover and/or whether the vehicle is parked.

5. The method claim 3, wherein whether the freeze protection is required during the vehicle stopover is determined when it is determined that there are no power needs from the vehicle during the vehicle stopover.

6. The method of claim 3, wherein whether the freeze protection is required during the vehicle stopover is determined when it is determined that there are power needs from the vehicle during the vehicle stopover and the power needs can be fulfilled by the electric energy storage system during the vehicle stopover.

7. The method of claim 3, further comprising:
if it is determined that there are power needs from the vehicle during the vehicle stopover and the power needs cannot be fulfilled by the electric energy storage system during the vehicle stopover, keeping at least one fuel cell system of the fuel cell systems operational.

8. The method of claim 2, further comprising:
if the estimated duration of the vehicle stopover expires before the threshold time, keeping at least one fuel cell system of the fuel cell systems operational, or restarting the at least one fuel cell system.

9. The method of claim 8, wherein the at least one fuel cell system is restarted after a certain time period during which the plurality of fuel cell systems are shut down.

10. The method of claim 7, further comprising selecting (222) the at least one fuel cell system by comparing values each representing a state of health of a respective fuel cell system of the plurality of fuel cell systems, and wherein the at least one fuel cell system has a highest value representing the state of health of the at least one fuel cell system.

11. The method of claim 1, wherein the threshold time is estimated using a first threshold time and a second threshold time, wherein the first threshold time is calculated for a case when the electric energy storage system is not capable of storing any of the power generated by the fuel cell systems during the vehicle stopover, and the second threshold time is calculated for a case when the electric energy storage system is capable of storing the entirety of power generated by the fuel cell systems during the vehicle stopover.

12. The method of claim 1, wherein the duration of the vehicle stopover is estimated using one or more of a driver input, location information, ambient information, and historical data related to operation of the vehicle.

13. The method of claim 1, wherein whether the freeze protection is required during the vehicle stopover is determined using current ambient conditions and predicted ambient conditions.

14. A control unit for controlling a power assembly of a vehicle comprising a plurality of fuel cell systems and an electric energy storage system, the control unit being configured to perform the method of claim 1.

15. A power assembly comprising a plurality of fuel cell systems and an electric energy storage system, the power assembly further comprising the control unit of claim 14.

16. A vehicle comprising the power assembly of claim 14.

17. A computer program product comprising instructions, which, when executed on at least one processor, cause the at least one processor to carry out the method of claim 1.

18. A no-transitory computer-readable storage medium, having stored thereon a computer program product comprising instructions which, when executed on at least one processor, cause the at least one processor to carry out the method of claim 1.
